(19) United States
(12) Patent Application Publication
(10) Pub. No.: US 2016/0069550 A1
(43) Pub. Date: Mar. 10, 2016

(54) Movement Device for Lighting Sources

(71) Applicant: FLEXSO S.R.L., Cicagna (IT)

(72) Inventor: Antonio SOLARI, Leivi (IT)

(21) Appl. No.: 14/785,129

(22) PCT Filed: Apr. 22, 2014
(86) PCT No.: PCT/EP2014/001065

§ 371 Date: Oct. 16, 2015

(30) Foreign Application Priority Data
Apr. 23, 2013 (IT) GE2013A000043

(51) Int. Cl. F21V 21/38; F21V 23/02; F21S 8/06; F21V 21/15; F21V 21/16

(52) U.S. Cl. CPC F21V 21/38; F21V 21/15; F21V 21/16; F21S 8/06; F21V 23/02; F21Y 2101/02

(57) ABSTRACT

Movement device (A), for at least one lighting source (I) which allows it to move up and down, including at least one housing (2) with at least an anchoring bracket (1) to the ceiling or like, the housing including an unrolling/rolling arrangement of a band (4) which connects the housing itself (2) to the lighting source (I) and which causes the mentioned movement up and down and a power supply for the lighting source by way of the band.

This invention refers to a movement device for lighting sources.

In particular, it regards a motorised lighting device able to move either down or up depending on needs and is able to simplify and make interventions of maintenance and cleaning safe for the people involved.

As well known, the subject who has to carry out maintenance and/or substitution of the luminous body in lighting devices of priori art that they are attached to the ceiling or, more simply, clean the device, works at a certain height from the ground using a step ladder or an adjustable work platform in order to reach it.

This makes such interventions hazardous for the personal safety of anyone who has to work on the step ladder or on the platform without, for that matter, being able to hold on to the same since normally his/her hands are employed to carry out the above mentioned interventions on the lighting device. Furthermore, for what concerns interventions of maintenance and/or substitution of light bulbs, the intervention of a specialist workman equipped with suitable means to reach the luminous body is often required as they are often placed at a considerable height from the ground, which means intervention costs of a certain amount.

Devices for moving lights up and down exist with springs or pulleys which can be moved by hand but they mainly concern lights of small dimensions that are quite light and require minimal effort by the user, while lighting devices of large dimensions, for instance, those generally used in industrial warehouses, in offices or in factories are fixed to the ceiling, determining the inconveniences pointed out above. What is more, they normally use a 220V current thereby increasing the risks to personal safety for individuals during the phases of maintenance or cleaning.

The aim of this invention is that of remedying such inconveniences by supplying a low-voltage lighting device having the features of the attached claim 1.

The invention will be explained better through the following description, in which the preferable form of implementation of the invention is described, made with the aid of the attached figures that illustrate respectively:

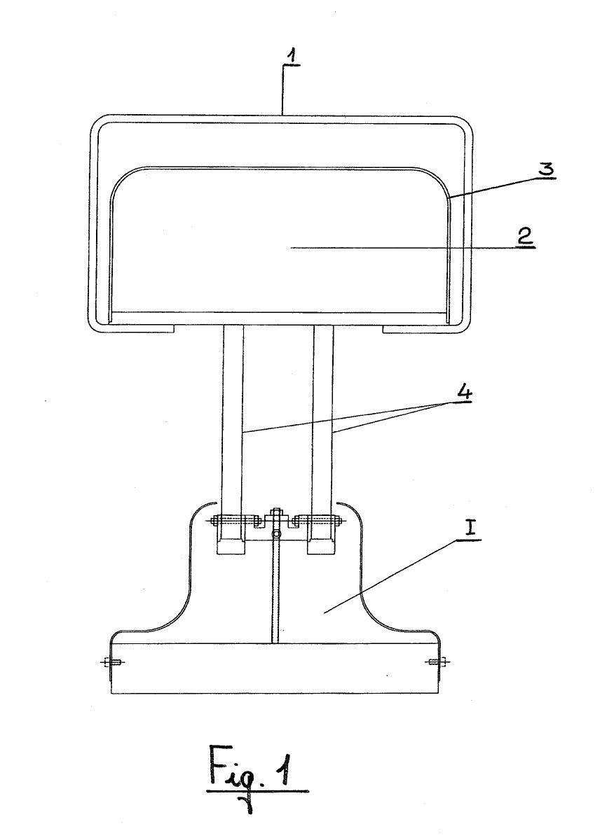

FIG. 1 illustrates the side view of the device according to this invention and a lighting source;

FIG. 2 illustrates the movement components of the device according to this invention;

FIG. 3 illustrates the side view of the internal mechanisms of the device according to this invention;

FIG. 4 illustrates an enlarged view of the end-of-run sensor of the device according to this invention;

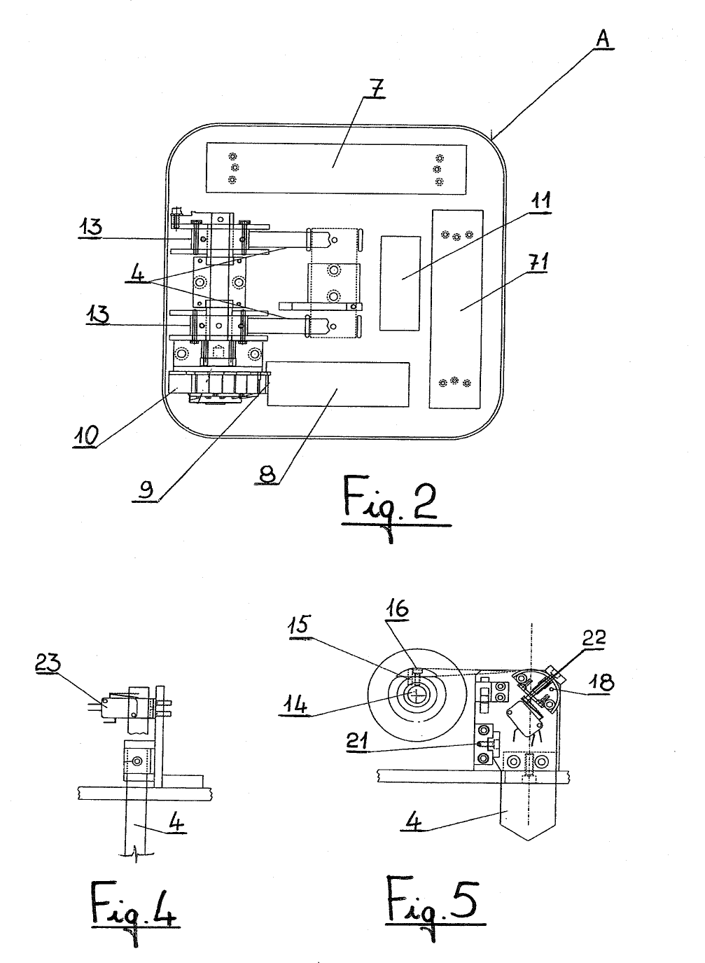

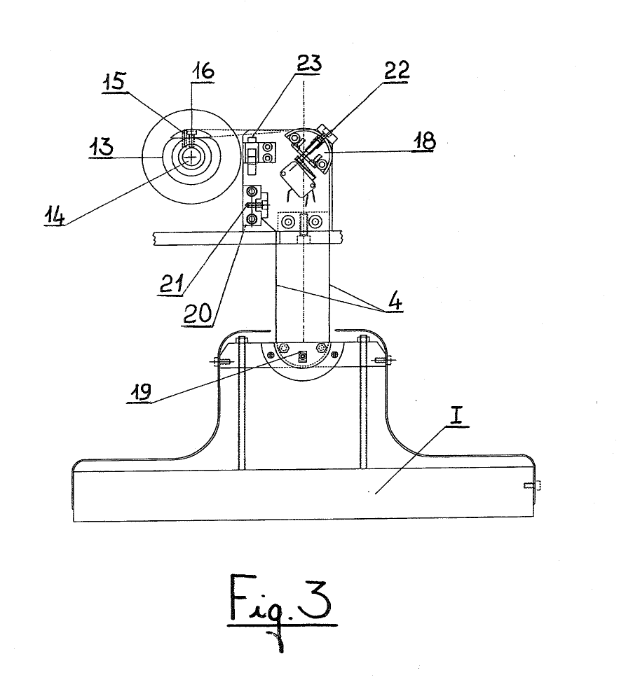

FIG. 5 illustrates an enlarged view of the transmission component according to this invention.

With reference to the above mentioned figures, the movement device A, according to this invention, is linked to at least one lighting source I, by means of metallic bands 4 for support and movement which allow an up and down movement for said source. Inside the device A all the components are housed for the movement and the power supply to said light source.

In particular, as indicated in FIG. 1, the device A is fitted on the ceiling with an anchoring bracket 1, whether on the flat or sloping, of at least one housing 2, fitted with a cover plate 3, the aim of which is to protect the mechanisms contained in said device from dust and collisions.

The metallic band 4 is preferably of stainless steel and electrically and mechanically connects the device to at least one lighting source I.

This latter source is, preferably, a 48-VDC LED light, fitted with interchangeable lenses placed in front of each light, in such way as to vary, at the user's pleasure, the cone of light. Said LED light allows, as well known, a considerable saving of electrical power supply energy, less weight and smaller dimensions for the lighting body compared to traditional lights.

Inside the housing 2 (FIG. 2), rolling and unrolling means are envisaged for the metallic band 4 which connects this housing to the source. Furthermore, power supply means for the source are envisaged through the band 4. In particular, inside the housing there is a power supply unit 7 for the LED light and a power supply unit 71 for the gear motor 8. The power supply unit 7, besides transforming the input voltage of the 220V current, is also able to protect the LED light bulbs from voltage surges and increase the lifespan of the lights.

The gear motor 8 allows movement in ascent or descent of the lighting source I by means of the band 4. Said gear motor is coupled with an internal worm screw 9 and a worm wheel 10, so as to maintain the lighting source I in a position of irreversible locking even in case of power failure. It is evident that the motor must be suitable with relation to the force necessary for the movement of the light and, therefore, the larger the light is, the more powerful the motor must be.

Furthermore, an electronic control board 11 is envisaged for the movement of the light through the use of a remote control, for instance with multi-frequency, which suitably regulates the phases of start and arrest so as to avoid sudden and, consequently, damaging movements of the light body. During the phases of movement the voltage is cut from the bands as a precaution thereby avoiding the occurrence of any possible malfunctions.

Inside the housing box winding coils 13 are inserted on which to wind the bands, fitted on an axis 14 preferably made of steel, of a non-conductive material, for instance plastic, so as to maintain insulation between the two bands. Blocking of the bands on the coil takes place by means of pin 15 and a safety screw 16. The coil furthest from the gear motor is not solidly joined to the other coil thereby allowing a fine regulation of the winding of the band onto its and perfect alignment of the light compared to a hypothetical horizontal plane.

In FIG. 3, the path of the bands is illustrated along with the main components that come into contact with the same ensuring a correct power supply and positioning of the light.

Band 4, during movement, slides along a first upper metallic transmission 18 through which the power supply current of the light is transmitted, after that it passes into a lower transmission 19 on the body of the light and is then blocked at its end, on a blocking element 20 of the housing 2 (FIG. 3) where there is a second power supply point 21. This to reduce to the minimum the electrical losses due to the resistance of the material.

When, by means of the gear motor, the band is wound and/or unwound, the lower transmission determines the raising or lowering of the lighting source in that the band can slide along it, while it is fixed to the blocking element 20 instead.

Inside the upper transmission 18 a spring sensor 22 is housed to verify contact between the band 4 and the transmission which allows blocking of the movement in case of meeting foreign bodies during the descent phase of the light. Should, instead, the light meet an obstacle in the ascent phase, it is blocked by a control board 11 which detects an anomalous absorption of current.

Finally, in order to prevent incorrect working conditions, a further sensor 23 is envisaged that, in case of reaching the lower limit of travel of the light (complete extension of the bands), signals the reaching of said limit and interrupts the rotation of the coil thereby avoiding the complete winding in the wrong sense of the band 4.

Lastly, the light is fed with a power supply and is able to project a beam of light in whatever position it is found and this is thanks to the bands 4. It is therefore possible to use the device regulating the lighting of the work area to one's own liking.

What is claimed is:

1. Movement device, for a lighting source which allows it to move up and down, comprising:
a housing with at least an anchoring bracket for connecting the housing to a ceiling or the like,
said housing including:
a band which connects the housing to said lighting source,
an unrolling/rolling arrangement for the band which connects the housing to said lighting source and which causes up and down movement of the lighting source, and
a power supply for the lighting source by way of said band.

2. Device according to claim 1, wherein said unrolling/rolling arrangement for the band includes:
winding coils for the band fitted on an axle, and
at least one gear motor supplied by a power supply unit for rotating the winding coils.

3. Device according to claim 2, wherein said at least one gear motor is coupled with the coils by an internal worm screw and a worm wheel, so as to maintain the lighting source in a position of irreversible locking even in case of power failure.

4. Device according to claim 1, wherein said power supply for the lighting source by way of said band comprises:
a first upper metallic transmission provided inside the housing by which a power supply voltage from the power supply is transmitted,
a lower transmission provided on a body of the lighting source, and
a blocking element of the housing, where there is a second power supply point, and on which an end of the band is blocked.

5. Device according to claim 4, further comprising a spring sensor accommodated inside the first upper metallic transmission and which is adapted to stop travel of the lighting source in case the lighting source meets foreign bodies during a descent phase of the lighting source.

6. Device according to claim 4, further comprising a control board adapted to stop travel of the lighting source in case the lighting source meets foreign bodies during a rise phase of the lighting source.

7. Device according to claim 4, further comprising a sensor which is adapted to stop travel of the lighting source in case of the lighting source reaching a lower limit of travel of the bands.

8. Device according to claim 1, wherein the lighting source is supplied and projects a beam of light in whatever position it is found.
